(19) United States
(12) Patent Application Publication
(10) Pub. No.: US 2008/0087333 A1
(43) Pub. Date: Apr. 17, 2008

(54) Mobile fluid feeding apparatus for a power tool

(75) Inventors: Ralf Pfeiffer, Landsberg (DE); Georg Holzmeier, Untermeitingen (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/974,161

(22) Filed: Oct. 10, 2007

(30) Foreign Application Priority Data
Oct. 12, 2006 (DE) 10 2006 035 345.5

(51) Int. Cl. B01D 24/00

(52) U.S. Cl. 137/547

(57) ABSTRACT

A mobile liquid conveying apparatus includes a service liquid area (10) having a service liquid outlet (18) for communicating with the power tool (4), a dirty liquid area (12) having a dirty liquid inlet (28) through which dirty liquid from the power tool (4) can flow into the dirty liquid area (12) with both the service liquid area and the dirty liquid area being provided in a common storage space (7), and a separation element for separating the service liquid area (10) from the dirty liquid area (12).

### BACKGROUND OF THE INVENTION

1. Field of the Invention

The invention relates to a liquid conveying apparatus for a power tool such as a cutting, drilling or grinding tool and which is constructed as a mobile unit and serves to supply rinsing liquid or cooling liquid and to carry off dirty liquid produced at the power tool during operation, for example, in the form of sludge water. For this purpose, the liquid conveying apparatus has a service liquid outlet, a dirty liquid inlet, and a storage volume having a service liquid area which can be connected with respect to flow to the service liquid outlet, and a dirty liquid area which can be connected with respect to flow to the dirty liquid inlet. The service liquid area is separated from the dirty liquid area.

2. Description of the Prior Art

Mobile liquid conveying apparatuses of the type mentioned above have the advantage that they are easy to transport so that it is possible to provide cooling liquid in a flexible manner and to eliminate dirty liquid simultaneously.

A liquid conveying apparatus for rock drilling tools which is constructed as a mobile unit is known from DE 212 463. It has a receptacle with a storage volume which is divided by a filter wall into a dirty water area and a service water area. Accordingly, service water that is used for cooling and rinsing can be pumped out of the service water area to the rock drilling machine. The sludge-containing service water then travels along a hose as dirty water to the dirty water area of the receptacle.

However, the known device is disadvantageous in that it is often impossible to find a suitable pore size for the filter which ensures a sufficient quality of the service water made available by the recurring filtration while at the same time preventing clogging of the filter and resulting lack of service water.

### SUMMARY OF THE INVENTION

It is the object of the present invention to overcome the above-mentioned disadvantages in a mobile liquid conveying apparatus and to increase the quantity and quality of the available service liquid.

According to the invention, the above-stated object is met by a mobile liquid conveying apparatus, wherein the service liquid area and the dirty liquid area are provided in a common storage space and are separated from one another by a separating element whose position can be changed. This makes it possible to use at least approximately the total storage volume for storing fresh service liquid at the start of the operation, while the dirty liquid area is substantially first formed when dirty liquid actually occurs in operation. In this way, the limited storage volume available in the mobile liquid conveying apparatuses can be used in an optimal manner and the entire storage volume is available for receiving service liquid, e.g., drinking water, at the start of operation.

In a particularly preferred embodiment form, the position of the separating element can be changed depending on a volume proportion of service liquid to a volume proportion of dirty liquid. In this way, the storage volume can be divided equally at any time during operation depending on the respective proportion of service liquid and dirty liquid.

The separating element is advantageously at least partially permeable. Therefore, it is possible to reclaim a portion of the used service liquid from the dirty liquid area by filtration.

The separating element is advantageously formed by an at least partially flexible receptacle. A flexible receptacle of this type makes it possible to divide the storage volume into the service liquid area and the dirty liquid area depending upon volume in a particularly simple manner.

In this respect, it is advantageous when the service liquid outlet is arranged in the receptacle. In this way, the receptacle can be used to store the service liquid, while a base outlet enabling a particularly convenient disposal of dirty liquid from the storage volume, e.g., into a waste water duct, can be provided at the rest of the liquid conveying apparatus, particularly at a bottom.

As an alternative to the above, the receptacle can advantageously be charged from the dirty liquid inlet. Accordingly, the dirty liquid area is extensively separated from the rest of the liquid conveying apparatus resulting in reduced contamination thereof.

The receptacle is advantageously held in the rest of the liquid conveying apparatus so as to be removable, so that the liquid conveying apparatus can also be used alternatively purely as a rinsing liquid supply device or dirty liquid discharge device and as an intermediate storage for pumping through rinsing liquid to the drilling device or dirty liquid to a waste water device such as a waste water duct.

In this respect, it is particularly advantageous when the receptacle is formed by a disposable receptacle so that, for example, the dirty liquid can be disposed of along with the receptacle.

Further, it is advantageous when the receptacle has a floatable bottom so that it can be positioned in a predetermined manner within the storage volume. Obstruction of inlets to or outlets from the storage volume can be prevented in this way, for example.

It is advantageous when the receptacle is formed by a bag to keep production costs for the receptacle as low as possible.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partially cross-sectional schematic view of an assembly including a liquid conveying apparatus according to the present invention and a power tool;

FIG. 2 a schematic view of the assembly according to FIG. 1 at the start of an operation;

FIG. 3 a schematic view of the assembly according to FIG. 1 toward the end of the operation;

FIG. 4 a partially cross-sectional schematic view of an assembly including another embodiment of liquid conveying apparatus according to the present invention and a power tool according to FIG. 1 at the start of an operation;

FIG. 5 a schematic view of the assembly according to FIG. 4 during an operation;

FIG. 6 a schematic view of the assembly according to FIG. 4 toward the end of an operation;

FIG. 7 a schematic view of the assembly according to FIGS. 1 to 3 in a pump-through operation; and

FIG. 8 a schematic view of the assembly according to FIGS. 4 to 6 in a pump-through operation.

### DETAILED DESCRIPTION OF THE PREFERRED EMBODIMENTS

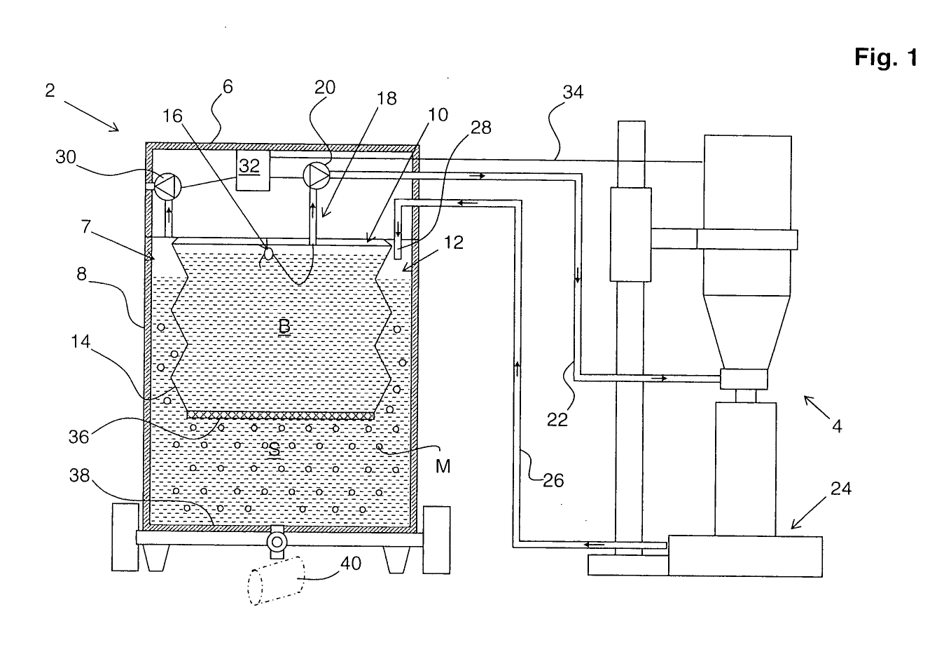

FIG. 1 shows a mobile liquid conveying apparatus 2 which serves to supply a power tool 4 in the form of a diamond core drill device with a service liquid B, particularly water. The relatively clean service liquid B is used, for example, to rinse or cool a working tool or work area. The liquid conveying apparatus 2 serves at the same time to carry off a dirty liquid S which occurs during the operation of the power tool 4 and which is substantially includes the used service liquid B and material particles M removed during operation.

For this purpose, the liquid conveying apparatus 2 has a storage receptacle 8 which can be closed by a cover 6 and which forms a storage space 7 in which a service liquid area 10 and a dirty liquid area 12 are provided. A flexible receptacle 14 in the form of a bag which is held in the storage receptacle 8 and which contains the service liquid area 10 serves as a separating element to separate the two areas 10, 12.

A float tap 16 of a service liquid outlet, designated in its entirety by 18, projects into the receptacle 14 and is connected to a drainage pump 20 in the form of a compression pump. The service liquid B is supplied to the power tool 4 via a supply line 22 from the service liquid area 10 during operation by means of this drainage pump 20, as is illustrated by arrows.

After flowing through a work area 24 of the power tool 4, the resulting dirty liquid S is carried away from the work area 24 by a disposal line 26 as is illustrated by arrows. For this purpose, the disposal line 26 is connected to a dirty liquid inlet 28 which opens into the dirty liquid area 12. The entire storage space 7 and accordingly also the dirty liquid area 12 can be evacuated by means of a suction pump 30. Due to the vacuum created in this way, the dirty liquid S is transported into the dirty liquid area 12 via the dirty liquid inlet 28 during operation.

The two pumps 20, 30 are controlled during operation by means of a control device 32 to which a power supply cable 34 of the power tool 4 is also connected.

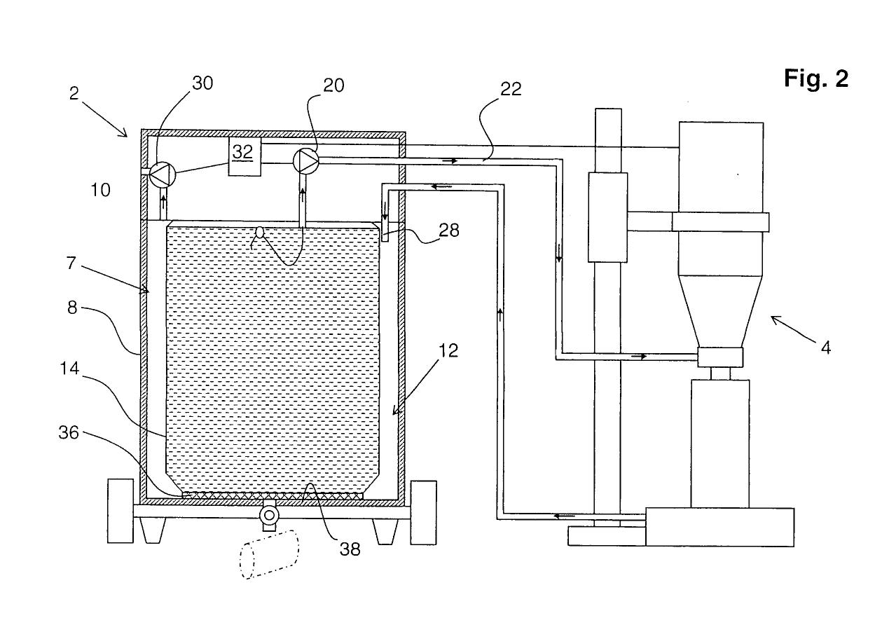

FIG. 2 shows the liquid conveying apparatus 2 before the start of an operation. At this time, the receptacle 14 is completely filled with the relatively clean service liquid B, for example, service water or drinking water. A float bottom 36 of the receptacle 14, which is formed, for example, from material which is relatively resistant to bending compared to the rest of the receptacle 14 and which has air pores, contacts the receptacle bottom 38 of the storage receptacle 8. The service liquid area 10 occupies virtually the entire storage space 7 of the storage receptacle 8, while the dirty liquid area 12 has a minimum volume and does not yet have dirty liquid S.

When the power tool 4 is turned on, the drainage pump 20 is also started under the control device 32 and now supplies the service liquid B to the power tool 4 from the service liquid area 10 via the supply line 22. Further, the suction pump 30 which generates a vacuum in the storage space 7 is also started by means of the control device 32. As a result, the dirty liquid S occurring in the work space 14 is conducted to the dirty liquid inlet 28 through which the dirty liquid area 12 is now filled.

In accordance with the view in FIG. 1, the dirty liquid area 12 is progressively filled during operation, while the volume of the service liquid B in the service liquid area 10 progressively decreases. As a result of the level of dirty liquid in the dirty liquid area 12 increases the level of the clean service liquid decreases, and the float bottom 36 gradually floats upward.

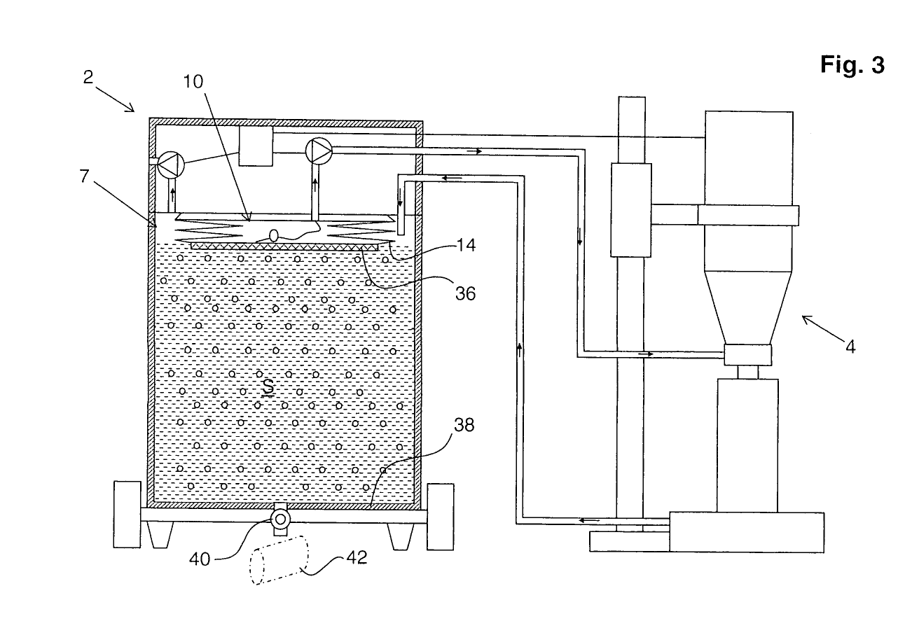

This process continues until the service liquid area 10 is completely empty as is shown in FIG. 3. As a result of the buoyancy of the float bottom 36, the receptacle 14 floats on the dirty liquid S which now almost completely fills the storage space 7. At this time, the service liquid area 10 has a minimum volume.

Before further operation of the liquid conveying apparatus 2, the dirty liquid S must first be removed. This is carried out by means of a base outlet 40 which is provided at the receptacle bottom 38 and through which the dirty liquid S can be conveyed, for example, to a disposal device 42, e.g., a waste water duct.

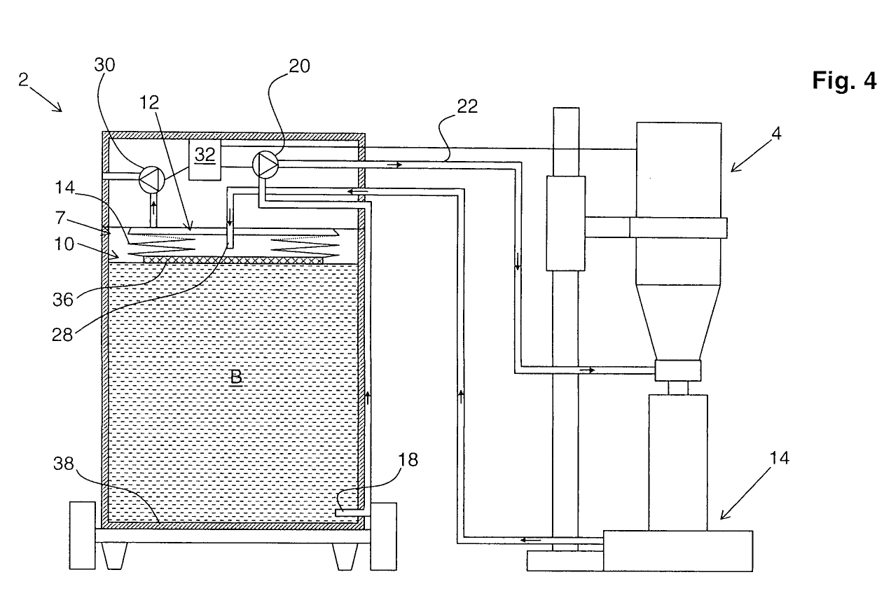

FIGS. 4 to 6 show an alternative embodiment of the liquid conveying apparatus 2 which essentially corresponds to the embodiment according to FIGS. 1 to 3. Identical elements or elements having the same function are therefore designated in a corresponding manner.

The essential difference of this embodiment from the embodiment shown in FIGS. 1-3 consists in the construction and apparatus of the service liquid outlet 18 and dirty liquid inlet 28. The dirty liquid inlet 28 is arranged in such a way that the receptacle 14 can now be charged through it. Accordingly, in this embodiment, the dirty liquid area 12 is arranged inside the receptacle 14, while the rest of the volume of the storage space 7 is used as the service liquid area 10.

FIG. 4 shows the liquid conveying apparatus 2 again before the start of operation. At this time, the service liquid area 10 is completely filled with the relatively clean service liquid B. The receptacle 14, which at this time is still empty, floats to the top of the service liquid B due to the buoyancy of the float bottom 36. The dirty liquid area 12 accordingly has a minimum volume.

When the power tool 4 is switched on, the drainage pump 20 is also started by means of the control device 20 and now conveys the service liquid B from the service liquid area 10 to the power tool 4 via the supply line 22. For this purpose, the service liquid outlet 18 is arranged next to the receptacle bottom 38 in this embodiment.

Further, the suction pump 30 is also started by means of the control device 32 and generates a vacuum in the storage space 7. As a result, the dirty liquid S, which is produced in the work space 14, is transported to the dirty liquid inlet 28 through which it fills the dirty liquid area 12 in the receptacle 14.

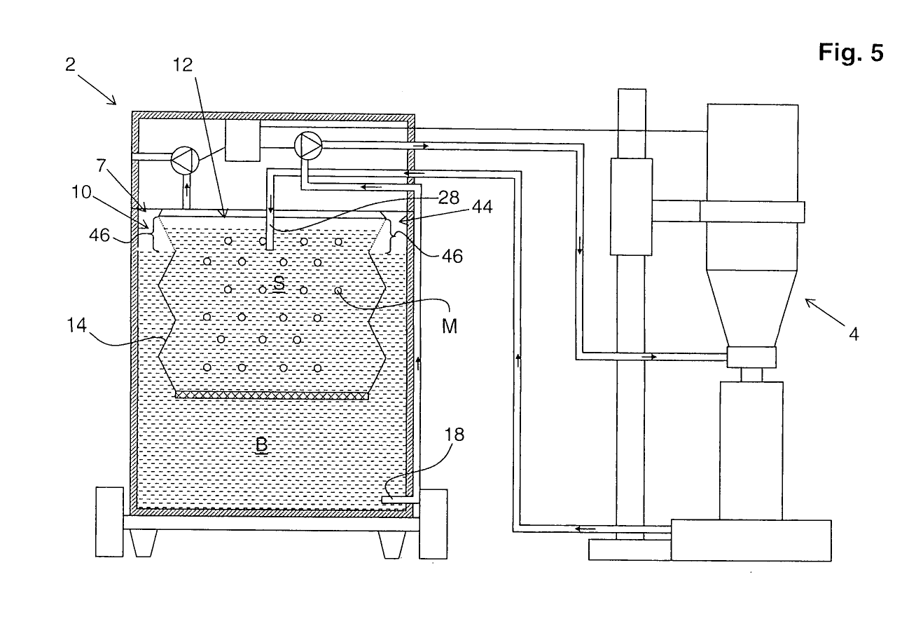

According to FIG. 5, the receptacle 14 or dirty liquid area 12 is progressively filled during operation, while the volume of the service liquid B in the rest of the storage space 7, i.e., in the service liquid area 10, progressively decreases. As a result of this, the level of dirty liquid in the receptacle 14 increases inversely to the level of the service liquid and the float bottom 36 progressively sinks.

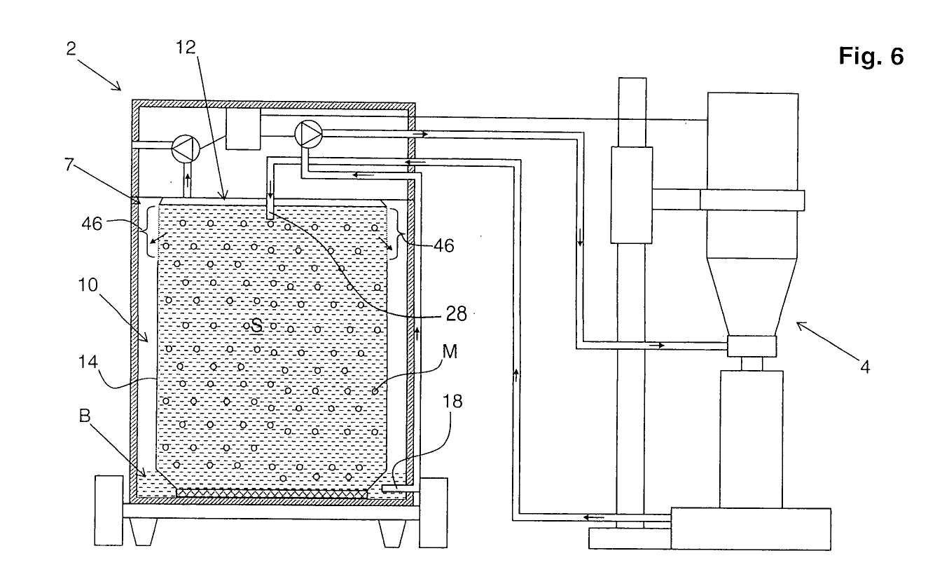

This process continues until the service liquid area 10 is almost completely empty, as shown in FIG. 6. As a result of the high level of the dirty liquid in relation to the minimum level in the service liquid area 10, the float bottom 36 of the receptacle 14 contacts the receptacle bottom 38. At this time, the service liquid area 10 has a minimum volume.

As can be seen particularly from FIGS. 5 and 6, the receptacle 14 can have a permeable area 46 at an upper end 44. This permeable area 46 contains pores which are dimensioned in such a way that the service liquid B contained in the dirty liquid S can outlet from the dirty liquid area 12 in this area 46, while the material particles M are retained in the receptacle 14 for the most part. To this end, a certain pressure difference between the dirty liquid S and the service liquid B, which occurs as a result of the buoyancy of the float bottom 36 in connection with a certain bending resistance of the receptacle 14 and particularly when the level of service liquid B is very low, is used. In this way, a portion of the occurring dirty liquid S is filtered and can be used to refill the service liquid area 10.

To dispose of the dirty liquid S, which is collected in the dirty liquid area 12, the receptacle 14 is held in the liquid conveying apparatus 2 so as to be removable and is formed by a disposable receptacle such as, e.g., a disposable bag. The receptacle 14 can accordingly be removed from the liquid conveying apparatus 2 and disposed of, together with the dirty liquid S contained therein. A new receptacle 14 can then be inserted in the liquid conveying apparatus 2, and the service liquid area 10 can be filled with fresh service liquid B.

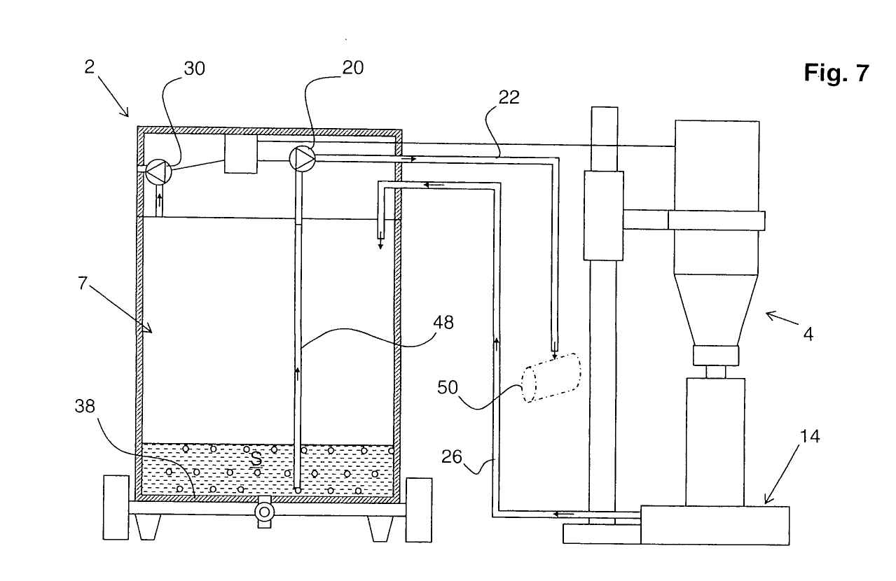

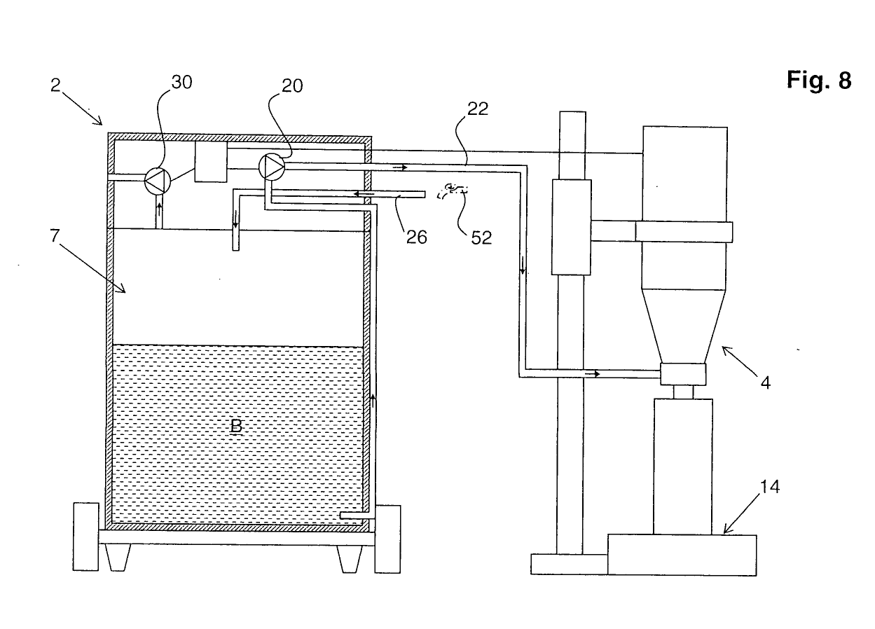

An additional advantage of the removable receptacle 14 consists in that the liquid conveying apparatus 2 can be used for pumping through service liquid B or dirty liquid S by means of a simple alteration, as shown in FIGS. 7 and 8.

FIG. 7 shows the liquid conveying apparatus 2 according to FIGS. 1 to 3, wherein the receptacle 14 is removed, and the float tap 16 has been replaced by a suction tube 48 at the service liquid outlet 18, with the suction tube 48 extending almost to the receptacle bottom 38. Further, the supply line 22 is now connected to the disposal device 42 instead of to the power tool 4.

In this instance, a vacuum is generated in the storage space 7 by the suction pump 30 during operation of the liquid conveying apparatus 2 and, as a result, the dirty liquid S produced in the work area 14 is aspirated via the disposal line 26. The dirty liquid S which is transported in this way into the storage space 7, which functions as an intermediate storage, is then pumped via the supply line 22 to the disposal device 42 by means of the drainage pump 20 which is formed for this purpose by a pump suitable for the dirty liquid.

FIG. 8 shows the liquid conveying apparatus 2 according to FIGS. 4 to 6, wherein the receptacle 14 is again removed, and the disposal line 26 is now connected to a supply device 50, e.g., in the form of a drinking water connection, rather than to the work area 14.

In this case, a vacuum can be generated in the storage space 7 during operation of the liquid conveying apparatus 2 by means of the suction pump 30 in order to assist in conveying service liquid B from the supply device 50. The service liquid B transported in this way into the storage space 7, which functions as an intermediate storage, and is then pumped via the supply line 22 to the power tool 4 by means of the drainage pump 20.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A mobile liquid conveying apparatus, comprising a common storage space (7); a service liquid area (10) provided in the common storage space (7) and having a service liquid outlet (18) for communicating with a power tool (4); a dirty liquid area (12) provided in the common storage space (7) and having a dirty liquid inlet (28) through which dirty liquid from the power tool (4) can flow into the dirty liquid area (12); and a separation element for separating the service liquid area (10) from the dirty liquid area (12) wherein the position of the separation element can be changed.

2. A mobile liquid conveying apparatus according to claim 1, wherein a position of the separating element can be changed depending on a service liquid level relative to a dirty liquid level.

3. A mobile liquid conveying apparatus according to claim 1, wherein the separating element is at least partially permeable.

4. A mobile liquid conveying apparatus according to claim 1, wherein the separating element is formed by an at least partially flexible receptacle (14).

5. A mobile liquid conveying apparatus according to claim 4, wherein the service water outlet (18) communicates with the receptacle (14).

6. A mobile liquid conveying apparatus according to claim 4, wherein the receptacle (14) can be filled via the dirty liquid inlet (28).

7. A mobile liquid conveying apparatus according to claim 5, wherein the receptacle (14) is removable from the liquid conveying apparatus (2).

8. A mobile liquid conveying apparatus according to claim 7, wherein the receptacle (14) is disposable.

9. A mobile liquid conveying apparatus according to claim 4, wherein the receptacle (14) has a floatable bottom (36).

10. A mobile liquid conveying apparatus according to claim 4, wherein the receptacle (14) is formed by a bag.
